(19) United States
(12) Patent Application Publication
(10) Pub. No.: US 2025/0004951 A1
(43) Pub. Date: Jan. 2, 2025

(54) APPLICATION CACHING OPTIMIZATION AND SYNCHRONIZATION

(71) Applicant: INTERNATIONAL BUSINESS MACHINES CORPORATION, ARMONK, NY (US)

(72) Inventors: Aaron K. Baughman, Cary, NC (US); Rahul Agarwal, Jersey City, NJ (US); Eduardo Morales, KEY BISCAYNE, FL (US); Gabriel Goodhart, Denver, CO (US)

(21) Appl. No.: 18/343,847

(22) Filed: Jun. 29, 2023

(51) Int. Cl. G06F 12/123

(52) U.S. Cl. CPC G06F 12/125

(57) ABSTRACT

An approach is provided for optimizing application caching and locking. Features specifying an operating environment of an application are extracted. The features include actual and forecasted central processing unit usage and memory, disk, and network pressure. A pairwise set of class-based and method-based ASTs and the extracted features are input into a logical neural network. Symbolic feature vectors are generated for the features by establishing bounds and flattening the features. The symbolic feature vectors and the set of class-based and method-based ASTs are input into a stacked transformer having encoders and decoders. The encoders and decoders are trained on word or token distributions of code ASTs and operating environment bounds associated with the ASTs. Using the stacked transformer, code is generated for replacing a portion of a method represented by a method-based AST. The code adds or changes caching or locking in the application.

### BACKGROUND

The present invention relates to application caching, and more particularly to application caching optimization and synchronization.

Caching is the process of storing data in a cache (i.e., a temporary storage area), and is used to speed up the performance of many applications. Cached data is stored temporarily in memory so that the data can be accessed quickly the next time the data is needed. Caching prevents many operations that are the same from being performed repeatedly, which can save time and resources, and prevent data errors. Some operations during caching, however, can corrupt the information if not synchronized appropriately. Caching also reduces the load on a server, which improves the overall system performance and scalability. Caching is especially beneficial for real-time events for which heavy calculations need to be done quickly. When a cache is full, caching algorithms direct which items should be discarded from the cache. Types of caching algorithms include, for example, Least Recently Used (LRU), Least Frequently Used (LFU), Most Recently Used (MRU), Expiring Cache, and Adaptive Replacement Cache. Synchronizing and locking cached data is important to eliminate data or code thrashing. The use of locks and thread safe data structures lock an instance until an executing process is finished. At that time, the cached unit is unlocked so that a follow-on thread can consume system resources. High scale and performant systems require the use of synchronizing data elements.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include determining a pairwise set of class-based and method-based abstract syntax trees (ASTs) of an application. The operations further include extracting features that specify an operating environment of the application. The features include memory pressure, forecasted memory pressure, central processing unit (CPU) usage, forecasted CPU usage, disk pressure, forecasted disk pressure, network pressure, and forecasted network pressure. The operations further include inputting (i) the pairwise set of class-based and method-based ASTs and (ii) the features into a logical neural network (LNN). The features are input into the LNN using automatic reinforcement learning based on the operating environment. The operations further include generating symbolic feature vectors for the features by establishing bounds for the features and flattening the features. The operations further include inputting the symbolic feature vectors for the features and the pairwise set of class-based and method-based ASTs into a stacked transformer having encoders and decoders. The encoders and decoders are trained on word or token distributions of ASTs specifying code and bounds of operating environments associated with the ASTs specifying code. The operations further include, using the stacked transformer, generating a code snippet that replaces a portion of a method which is represented by a method-based AST included in the method-based ASTs. The code snippet adds caching in the application, changes caching in the application, adds locking in the application, or changes locking in the application.

A computer program product and a method corresponding to the above-summarized computer system are also described and claimed herein.

### BRIEF DESCRIPTION OF THE DRAWINGS

FIG. 1 is a block diagram of a system for optimizing application caching and locking, in accordance with embodiments of the present invention.

FIG. 2 is a block diagram of modules included in code included in the system of FIG. 1, in accordance with embodiments of the present invention.

FIG. 3 is a flowchart of a process of optimizing application caching and locking, where the operations of the flowchart are performed by the modules in FIG. 2, in accordance with embodiments of the present invention.

FIG. 4 is a block diagram of an AST input system for constructing class and method-based ASTs and inputting the ASTs into a logical neural network, where the AST input system is implemented by code included in the system of FIG. 1, in accordance with embodiments of the present invention.

FIG. 5 is a block diagram of an application caching and locking optimization system, which is implemented by code included in the system of FIG. 1, in accordance with embodiments of the present invention.

FIG. 6 is an example of output generated by the system of FIG. 1, in accordance with embodiments of the present invention.

### DETAILED DESCRIPTION

### Overview

Determining an optimal caching and locking solution using known techniques is very difficult. Each application has a code base and a runtime signature over time. The performance of the application is isolated within a container and deployed within a self-contained server. A certain amount of memory and central processing units (CPUs) or virtualized CPUs (vCPUs) are allocated to a computing system. The application code, however, may not be optimized for the container of deployment. Moreover, some computing systems may have memory, internet, and/or computation limitations set by a platform, such as the OpenShift® platform. OpenShift is a registered trademark of Red Hat, Inc. located in Raleigh, North Carolina.

Using known caching techniques, the selection of a particular caching algorithm depends on the parameters of the platform on which the solution is being deployed and is based on human experience with previous selections of caching algorithms. For example, a software engineer working on a current project and who has worked on multiple similar projects in the past may make an experience-based decision to use LFU for the current project because the software engineer knows that the selection of LFU has worked well for the previous projects.

Moreover, when a piece of data or code is cached, many threads from the same application might access the unit in parallel. Multi-threaded applications require the use of locks to synchronize the utilization of shared resources, which becomes especially important when multiple threads change the same referenced data structure in a cache or apply a machine learning model. Locking data or code creates a delay in accessing the data or code. If caching is used to increase the speed of accessing the data or code, then the locking may make it more difficult for the caching to reach its optimal speed of access.

Within cloud computing, although an application is provisioned and deployed on one vendor's systems, another vendor can have similar but different offerings. For example, the cloud computing services offered by a first vendor may use the OpenShift® platform, which has particular volume sizes, memory capabilities, and CPU and Graphics Processing Unit (GPU) signatures. A second vendor may provide a similar experience with the OpenShift® platform, but have different volume sizes, memory capabilities, and CPU and GPU signatures. Because of these differences, a manual tuning of a caching system to be optimized for the first vendor does not translate exactly to an optimized caching system for the second vendor.

Embodiments of the present invention address the aforementioned unique challenges by providing a generative artificial intelligence (AI) algorithm that works on the application level and that modifies the application given the operating environment and original code base. The generative AI algorithm automatically determines the methods, calls, and data that need caching and locking, and further selects a type of caching algorithm that optimizes the caching solution. The AI-based technique described herein considers the aforementioned signatures and limitations when determining the optimal caching and locking solution. In one embodiment, the performance of the application being modified by the caching and locking optimization technique described herein is isolated within a container and deployed within a self-contained server.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

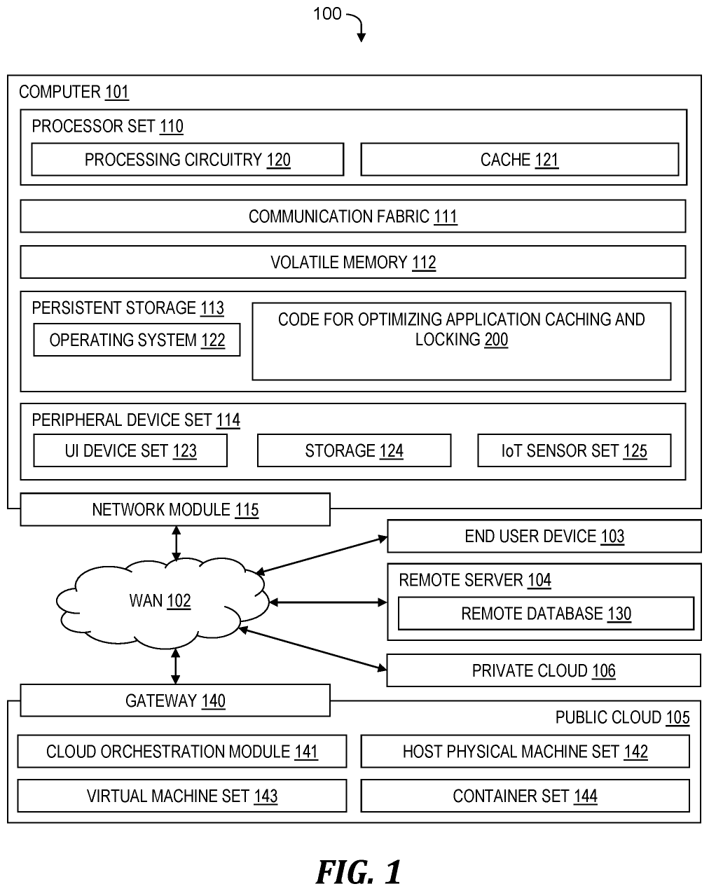

FIG. 1 is a block diagram of a system for optimizing application caching and locking, in accordance with embodiments of the present invention. Computing environment 100 contains an example of an environment for the execution of at least some of the computer code involved in performing the inventive methods, such as code 200 for optimizing application caching and locking. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Optimizing Application Caching and Locking

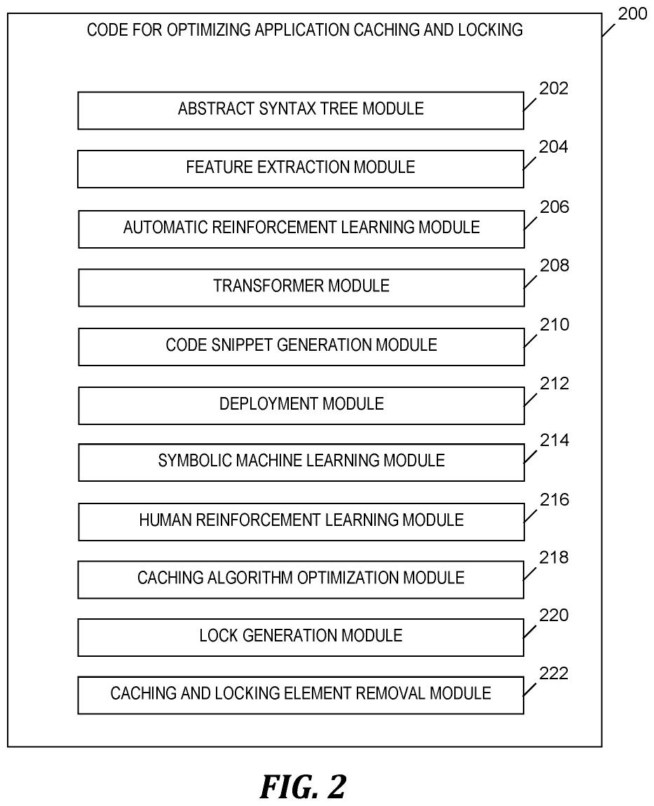

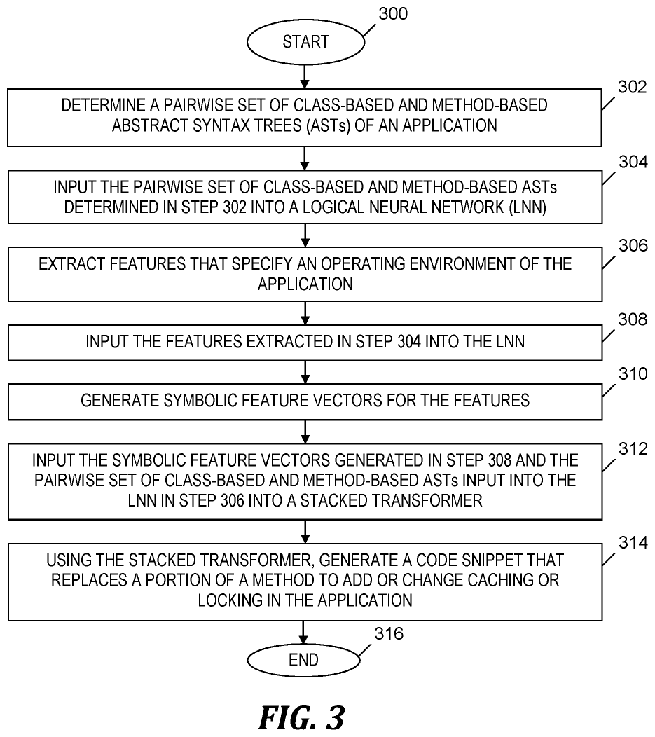

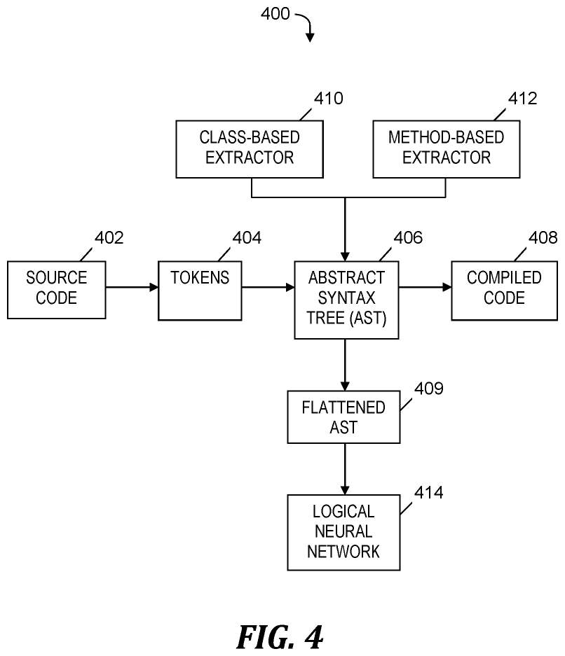

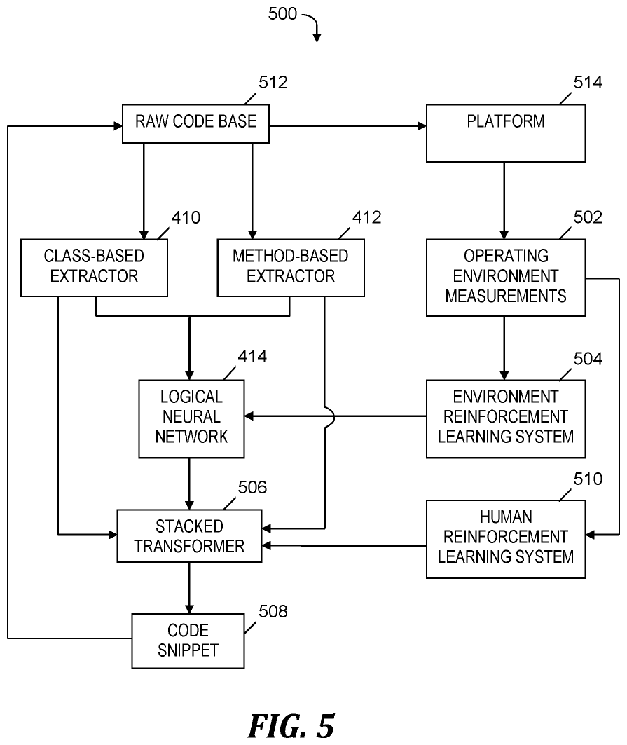

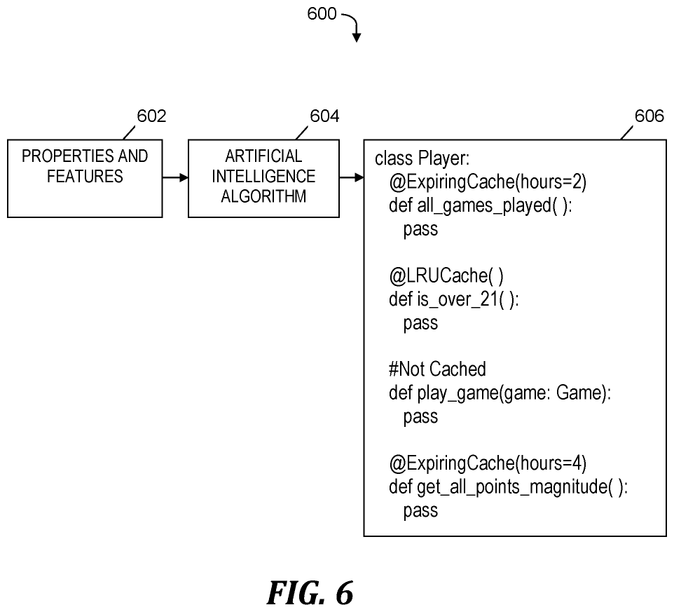

FIG. 2 is a block diagram of modules included in code included in the system of FIG. 1, in accordance with embodiments of the present invention. Code 200 includes an abstract syntax tree (AST) module 202, a feature extraction module 204, an automatic reinforcement learning module 206, a transformer module 208, a code snippet generation module 210, a deployment module 212, a symbolic machine learning module 214, a human reinforcement learning module 216, a caching algorithm optimization module 218, a lock generation module 220, and a caching and locking element removal module 222. The functionality of the modules included in code 200 is included in detail in the discussions of FIG. 3, FIG. 4, FIG. 5, and FIG. 6, which are presented below.

FIG. 3 is a flowchart of a process of optimizing application caching and locking, where the operations of the flowchart are performed by the modules in FIG. 2, in accordance with embodiments of the present invention. The process of FIG. 3 begins at a start node 300. In step 302, AST module 202 determines a pairwise set of class-based ASTs and method-based ASTs of an application.

In step 304, AST module 202 inputs the pairwise set of class-based and method-based ASTs determined in step 302 into a logical neural network (LNN). The LNN is a type of a recurrent neural network.

In step 306, feature extraction module 204 extracts features that specify an operating environment of the application.

In step 308, automatic reinforcement learning module 206 inputs the features extracted in step 306 into the LNN.

In step 310, transformer module 208 generates symbolic feature vectors for the features inputted into the LNN in step 308.

In step 312, transformer module 208 inputs the symbolic feature vectors generated in step 310 and the pairwise set of class-based and method-based ASTs inputted into the LNN in step 304 into a stacked transformer.

In step 314, using the stacked transformer, code snippet generation module 210 generates a code snippet that replaces a portion of a method to add caching to the application, change caching in the application, add locking in the application, or change locking in the application.

Following step 314, the process of FIG. 3 ends at an end node 316.

In one embodiment, symbolic machine learning module 214 (i) determines a first order logic (FOL) within the operating environment of the application by using symbolic machine learning of class-based ASTs and method-based ASTs of applications and (ii) based on the FOL, generates an association between an AST of the application and parameters of the operating environment. The code snippet generated by code snippet generation module 210 in step 314 is based on the aforementioned association between the AST of the application and the parameters (i.e., measurements) of the operating environment.

In one embodiment, a training module (not shown in FIG. 2) (i) generates and trains tuples by using passive reinforcement learning; (ii) generates subsets of the LNN by using the trained tuples and the first order logic within the operating environment; and (iii) based on the generated subsets of the LNN, identifies a change in a portion of code of the application as being related to parameters of the operating environment.

In one embodiment, using the aforementioned passive reinforcement learning, an application caching and locking optimization system that implements the process of FIG. 3 and employs the modules in FIG. 2 takes as input both the ASTs and the operating environment parameters to train the LNN and generate subsets of the LNN so that the system identifies which AST or change in code is related to which set of operating environment parameters. The training of the LNN is ongoing so that over time, the output of the system becomes more accurate.

In one embodiment, transformer module 208 (i) flattens the FOL, which is set within the operating environment of the application; (ii) flattens the ASTs included in the method-based ASTs; and (iii) inputs the flattened FOL and flattened ASTs into the stacked transformer. The generation of the code snippet by the code snippet generation module 210 in step 314 is based on the flattened FOL and the flattened ASTs.

In one embodiment, human reinforcement learning module 216 receives a feedback from a human developer, where the feedback includes values that specify a relative importance of cache-based encoding versus lock-based encoding. The generation of the code snippet by the code snippet generation module 210 in step 314 is based on the received feedback.

In one embodiment, caching algorithm optimization module 218 (i) determines a signature and a return type of a method which is represented by a method-based AST included in the method-based ASTs determined in step 302; (ii) determines a runtime performance specified by parameters of the operating environment of the application; and (iii) based on the signature, the return type, and the runtime performance, determines an optimal caching algorithm for the method. The signature is a specification of the input parameters to the method. Caching algorithm optimization module 218 determines the signature and return type by analyzing the AST. The generation of the code snippet by the code snippet generation module 210 in step 314 is based on the optimal caching algorithm.

A code snippet generated in step 314 that introduces a caching element and generates an optimal caching algorithm can present issues related to where locks need to be placed for non-thread safe cache elements. In one embodiment, lock generation module 220 (i) identifies atomic caching strategies and groups of nested atomic caching strategies specified by the code snippet generated in step 314; and (ii) based on the identified atomic caching strategies and groups of nested atomic caching strategies, generates a lock for the application which transforms non-thread safe cache elements in the application into thread safe cache elements.

In one embodiment, caching and locking element removal module 222 (i) determines that the code snippet generated in step 314 includes a pre-existing sub-optimal caching element and a pre-existing sub-optimal locking element in the application; and (ii) in response to the generation of the code snippet in step 314, removes the pre-existing caching element and the pre-existing locking element from the application. In one embodiment, caching and locking element removal module 222 removes the caching and locking elements during training of the system and performs the removal even during the first iteration of the training.

In one embodiment, code 200 includes a module (not shown) for translating first order logic and AST learned through semi-supervised examples of manually tuned caching and locking code in fixed environments.

In one embodiment, code 200 includes a module (not shown) for generating an encoded embedding space representing runtime performance and data access semantics which is used for optimizing application caching and locking and is also configured to be used for a purpose that is not related to application caching and locking optimization.

FIG. 4 is a block diagram of an AST input system 400 for constructing class and method-based ASTs and inputting the ASTs into a logical neural network, where the AST input system is implemented by code included in the system of FIG. 1, in accordance with embodiments of the present invention. AST input system 400 tokenizes a source code 402 to generate tokens 404, and converts tokens 404 into AST 406, which is a tokenized abstract syntax tree. AST input system 400 includes an engine (not shown) that uses AST 406 to generate and execute compiled code 408. For example, AST input system 400 uses a module (not shown) provided in a standard library of the Python® programming language to create AST 406 and a Python® engine (not shown) uses AST 406 to execute compiled code 408. Python is a registered trademark of Python Software Foundation located in Beaverton, Oregon.

AST input system 400 flattens AST 406 into a flattened AST 409 (i.e., a token-based vector). AST input system 400 further includes (i) a class-based extractor 410 that extracts a class that includes one or more methods in an application and (ii) a method-based extractor 412 that extracts methods within an extracted class. AST input system 400 generates a pairwise set of class-based ASTs and method-based ASTs, which consists of pairs of ASTs. Each of the aforementioned pairs includes (i) a method extracted by method-based extractor 412 and (ii) a class extracted by class-based extractor 410, where the class is the class of the method included in the pair. To generate the pairwise set of class-based ASTs and method-based ASTs, AST input system 400 uses class-based extractor 410 and method-based extractor 412 to iterate over all methods within a class, including instance and class methods, and subsequently iterate over all classes. In step 304 (see FIG. 3), AST input system 400 inputs the pairwise set of class-based and method-based ASTs into a logical neural network (LNN) 414. The aforementioned generation of the pairwise set of class-based ASTs and method-based ASTs is included in step 302 (see FIG. 3).

FIG. 5 is a block diagram of an application caching and locking optimization system, which is implemented by code included in the system of FIG. 1, in accordance with embodiments of the present invention. Application caching and locking code snippet generation system 500 includes logical neural network (LNN) 414 which is trained on a set of rules and logical representations of the pairs of class-based and method-based ASTs that are extracted by class-based extractor 410 and method-based extractor 410, respectively, as described above in the discussion relative to FIG. 4. Furthermore, application caching and locking code snippet generation system 500 extracts features that specify an operating environment of the application. The features are also referred to herein as operating environment measurements 502 and include an actual memory pressure, a forecasted memory pressure, an actual central processing unit (CPU) usage, a forecasted CPU usage, an actual disk pressure, a forecasted disk pressure, an actual network pressure, and a forecasted network pressure. The extraction of the features is included in step 306 (see FIG. 3).

Application caching and locking code snippet generation system 500 generates a flattened feature vector from the extracted features and inputs the flattened extracted features into an environment reinforcement learning system 504, which employs automatic reinforcement learning based on the operating environment. The inputting of the flattened extracted features is included in step 308 (see FIG. 3).

Because logical neural networks such as LNN 414 implement the truth functions of the logical operations that the functions represent; i.e., ∧, ∨, ¬, →, and in first order logic, ∀ and ∃, application caching and locking code snippet generation system 500 obtains bounded truth values that associate the code to the operating environment. Application caching and locking code snippet generation system 500 queries specific portions of an AST to determine which areas of LNN 414 are responsible for the bounds and truth tables for memory pressure, CPU usage, disk pressure, and network pressure. During automatic reinforcement learning, if a measurement of a feature within the operating environment is worsening, then application caching and locking code snippet generation system 500 queries LNN 414 to identify that portion of LNN 414 that is responsible for the first order logic relating to the worsening measurement of the operating environment. Application caching and locking code snippet generation system 500 either increases or decreases the bounds of the first order logic as a target rule to match the step size improvement or decrease in performance. Using this target rule, application caching and locking code snippet generation system 500 isolates training on the identified portion of LNN 414 for targeting learning.

Application caching and locking code snippet generation system 500 establishes and flattens the bounds for memory pressure, CPU usage, disk pressure, and network pressure into a symbolic feature vector, which is included in step 310 (see FIG. 3). Application caching and locking code snippet generation system 500 inputs the flattened ASTs and symbolic feature vectors into a stacked transformer 506, which has stacks of encoders and decoders that have been trained on word or token distributions of code ASTs and operating environment bounds associated with the code ASTs. In one embodiment, the aforementioned inputting of the flattened ASTs and the symbolic feature vectors in stacked transformer 506 is included in step 312 (see FIG. 3).

A neural network-based language model is used by LNN 414 to associate the inputs to LNN 414 similar to n-grams within statistical language models. Stacked transformer 506 converts the ASTs and LNN rules into a generated code snippet 508. The encoders are trained on pieces of feature vector-based tokens that include caching strategies and locks. The encoders have learned the representation of code. The decoders then translate the encodings by feeding forward up through a stack to generate code snippet 508 that replaces the method (or a portion of the method) that the method-based AST represents. In one embodiment, the generation of the code snippet 508 by the decoders translating the encodings is included in step 314 (see FIG. 3).

Stacked transformer 506 receives other code of the application from class-based extractor 410 and method-based extractor 412, where stacked transformer 506 inserts the generated code snippet 508 into the received other code to re-create the code of the application, except that the re-created code includes the caching and locking provided by the generated code snippets, such as code snippet 508.

Application caching and locking code snippet generation system 500 generates code snippet 508 and inserts the generated code snippet 508 in a raw code base 512 of the application. Using raw code base 512 that includes generated code snippet 508, application caching and locking code snippet generation system 500 performs the process of code snippet generation in a subsequent iteration to further optimize or validate the caching and locking provided by the generated code snippets. This repeating of the process of code snippet generation includes application caching and locking code snippet generation system 500 using raw code base 512 to again generate class-based extractor 410 and method-based extractor 412.

Application caching and locking code snippet generation system 500 deploys raw code base 512, which includes code snippet 508, to a platform 514 for deploying the application. Platform 514 can be, for example, an OpenShift® or Kubernetes® platform. Kubernetes is a registered trademark of The Linux Foundation located in San Francisco, California. In one embodiment, deployment module 212 (see FIG. 2) performs the deployment of raw code base 512 to platform 514.

In one embodiment, an architecture of stacked transformer 506 includes an attention mechanism (not shown) that identifies and focuses on the tokens that represent caching and locks. In one embodiment, the stacked transformer 506 gives a weight to the embedding space that includes tokens that represent caching and locks that is greater than weights of other tokens, thereby allowing the aforementioned tokens to have an influence on the generated code snippet 508 that is greater than the influence of other tokens.

In one embodiment, stacked transformer 506 biases (i.e., increases the weight of) multi-head attention mechanisms to favor the tokens and embeddings that focus on the caching and locking code.

A human reinforcement learning system 510 enables a human developer to provide values that indicate the importance of caching and lock-based embeddings in stacked transformer 506. Human reinforcement learning system 510 sends the aforementioned values that indicate the importance of caching and lock-based embeddings to stacked transformer 506. In one embodiment, a human operator assigns the relative importance of caching versus lock-based embeddings by assigning values in the range [0,1] to caching and lock-based embeddings, such that the sum of the two values equals one (e.g., 0.6 is assigned to caching and 0.4 is assigned to lock-based embedding). For example, assigning an increased value to the lock-based embeddings and assigning a corresponding decreased value to the caching causes the speed of the application to be decreased while the certainty and accuracy of the results of the application is increased. Modules (not shown) included in human reinforcement learning system 510 use q-table learning to update the influence attention mechanisms (not shown) that are distributed across the architecture of stacked transformer 506.

In one embodiment, a system for optimizing application caching and locking includes the systems discussed above relative to FIG. 4 and FIG. 5, and implements the process discussed above relative to FIG. 3.

FIG. 6 is an example 600 of output generated by the system of FIG. 1, in accordance with embodiments of the present invention. Example 600 includes properties and features 602 of a function in an application and an artificial intelligence (AI) algorithm 604 included in code 200 for optimizing application caching and locking. A system for optimizing caching and locking that includes AST input system 400 (see FIG. 4) and application caching and locking code snippet generation system 500 (see FIG. 5) inputs properties and features 602 of the function to AI algorithm 604, which determines the answers to caching and locking questions relative to the function. For example, AI algorithm 604 determines answers to questions such as:
(i) Should the function be cached?
(ii) What type of caching algorithm should be used?
(iii) Should the caching expire?

After determining the answers to the caching and locking questions, AI algorithm 604 generates an output 606, which includes @ExpiringCache(hours=2) and @ExpiringCache(hours=4), which are code snippets generated by AI algorithm 604 in response to AI algorithm 60 determining that the functions all_games_played( ) and get_all_points_maginitude( ), respectively, should be cached and the caches should expire. Output 606 also includes @LRUCache( ), which is a code snippet generated by AI algorithm 604 in response to AI algorithm determining that the function is_over_21( ) should be cached and the caching algorithm should be LRU. Output 606 also includes #Not Cached, which is a code snippet generated by AI algorithm 604 in response to AI algorithm 604 determining that the function play_game(game: Game) should not be cached.

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
determining a pairwise set of class-based and method-based abstract syntax trees (ASTs) of an application;
extracting features that specify an operating environment of the application, wherein the features include memory pressure, forecasted memory pressure, central processing unit (CPU) usage, forecasted CPU usage, disk pressure, forecasted disk pressure, network pressure, and forecasted network pressure;
inputting (i) the pairwise set of class-based and method-based ASTs and (ii) the features into a logical neural network (LNN), the features being input into the LNN using automatic reinforcement learning based on the operating environment;
generating symbolic feature vectors for the features by establishing bounds for the features and flattening the features;
inputting the symbolic feature vectors for the features and the pairwise set of class-based and method-based ASTs into a stacked transformer having encoders and decoders, the encoders and decoders being trained on word or token distributions of ASTs of code and bounds of operating environments associated with the ASTs of code; and
using the stacked transformer, generating a code snippet that replaces a portion of a method which is represented by a method-based AST included in the method-based ASTs, wherein the code snippet adds caching in the application, changes caching in the application, adds locking in the application, or changes locking in the application.

2. The computer system of claim 1, wherein the computer readable code further includes the data and the instructions to cause the one or more computer processors to perform the following further operations:
determining a first order logic (FOL) within the operating environment by using symbolic machine learning of class-based and method-based ASTs of applications; and
based on the FOL, generating an association between an AST of the application and parameters of the operating environment of the application, wherein the generating the code snippet is based on the association.

3. The computer system of claim 1, wherein the computer readable code further includes the data and the instructions to cause the one or more computer processors to perform the following further operations:
generating and training tuples by using passive reinforcement learning;
generating subsets of the LNN by using the trained tuples and first order logic within the operating environment; and
based on the generated subsets of the LNN, identifying a change in a portion of code of the application being related to parameters of the operating environment.

4. The computer system of claim 1, wherein the computer readable code further includes the data and the instructions to cause the one or more computer processors to perform the following further operations:
flattening first order logic (FOL) which is set within the operating environment;
flattening the ASTs included in the method-based ASTs; and
inputting the flattened FOL and the flattened ASTs into the stacked transformer, wherein the generating the code snippet is based on the flattened FOL and the flattened ASTs.

5. The computer system of claim 1, wherein the computer readable code further includes the data and the instructions to cause the one or more computer processors to perform the following further operation:
receiving a feedback from a developer about a relative importance of cache-based encoding versus lock-based encoding, wherein the generating the code snippet is based on the received feedback.

6. The computer system of claim 1, wherein the computer readable code further includes the data and the instructions to cause the one or more computer processors to perform the following further operations:
determining a signature and a return type of a method which is represented by a method-based AST included in the method-based ASTs;
determining a runtime performance specified by parameters of the operating environment; and
based on the signature, the return type, and the runtime performance, determining an optimal caching algorithm for the method, wherein the generating the code snippet is based on the optimal caching algorithm.

7. The computer system of claim 1, wherein the computer readable code further includes the data and the instructions to cause the one or more computer processors to perform the following further operations:
identifying atomic caching strategies and groups of nested atomic caching strategies specified by the code snippet; and
based on the atomic and groups of nested atomic caching strategies, generating a lock for the application which transforms non-thread safe cache elements in the application into thread safe cache elements.

8. The computer system of claim 1, wherein the computer readable code further includes the data and the instructions to cause the one or more computer processors to perform the following further operations:
determining that the code snippet includes a pre-existing caching element and a pre-existing locking element in the application; and
in response to the generating the code snippet, removing the pre-existing caching and locking elements from the application.

9. A computer program product comprising:
one or more computer readable storage media having computer readable program code collectively stored on the one or more computer readable storage media, the computer readable program code being executed by one or more processors of a computer system to cause the computer system to perform at least the following operations:
determining a pairwise set of class-based and method-based abstract syntax trees (ASTs) of an application;
extracting features that specify an operating environment of the application, wherein the features include memory pressure, forecasted memory pressure, central processing unit (CPU) usage, forecasted CPU usage, disk pressure, forecasted disk pressure, network pressure, and forecasted network pressure;
inputting (i) the pairwise set of class-based and method-based ASTs and (ii) the features into a logical neural network (LNN), the features being input into the LNN using automatic reinforcement learning based on the operating environment;
generating symbolic feature vectors for the features by establishing bounds for the features and flattening the features;
inputting the symbolic feature vectors for the features and the pairwise set of class-based and method-based ASTs into a stacked transformer having encoders and decoders, the encoders and decoders being trained on word or token distributions of ASTs of code and bounds of operating environments associated with the ASTs of code; and
using the stacked transformer, generating a code snippet that replaces a portion of a method which is represented by a method-based AST included in the method-based ASTs, wherein the code snippet adds caching in the application, changes caching in the application, adds locking in the application, or changes locking in the application.

10. The computer program product of claim 9, wherein the computer readable program code is executed by the one or more processors to cause the computer system to perform the following further operations:
determining a first order logic (FOL) within the operating environment by using symbolic machine learning of class-based and method-based ASTs of applications; and
based on the FOL, generating an association between an AST of the application and parameters of the operating environment of the application, wherein the generating the code snippet is based on the association.

11. The computer program product of claim 9, wherein the computer readable program code is executed by the one or more processors to cause the computer system to perform the following further operations:
generating and training tuples by using passive reinforcement learning;
generating subsets of the LNN by using the trained tuples and first order logic within the operating environment; and
based on the generated subsets of the LNN, identifying a change in a portion of code of the application being related to parameters of the operating environment.

12. The computer program product of claim 9, wherein the computer readable program code is executed by the one or more processors to cause the computer system to perform the following further operations:
flattening first order logic (FOL) which is set within the operating environment;
flattening the ASTs included in the method-based ASTs; and
inputting the flattened FOL and the flattened ASTs into the stacked transformer, wherein the generating the code snippet is based on the flattened FOL and the flattened ASTs.

13. The computer program product of claim 9, wherein the computer readable program code is executed by the one or more processors to cause the computer system to perform the following further operation:
receiving a feedback from a developer about a relative importance of cache-based encoding versus lock-based encoding, wherein the generating the code snippet is based on the received feedback.

14. The computer program product of claim 9, wherein the computer readable program code is executed by the one or more processors to cause the computer system to perform the following further operations:
determining a signature and a return type of a method which is represented by a method-based AST included in the method-based ASTs;
determining a runtime performance specified by parameters of the operating environment; and
based on the signature, the return type, and the runtime performance, determining an optimal caching algorithm for the method, wherein the generating the code snippet is based on the optimal caching algorithm.

15. The computer program product of claim 9, wherein the computer readable program code is executed by the one or more processors to cause the computer system to perform the following further operations:
identifying atomic caching strategies and groups of nested atomic caching strategies specified by the code snippet; and
based on the atomic and groups of nested atomic caching strategies, generating a lock for the application which transforms non-thread safe cache elements in the application into thread safe cache elements.

16. The computer program product of claim 9, wherein the computer readable program code is executed by the one or more processors to cause the computer system to perform the following further operations:
determining that the code snippet includes a pre-existing caching element and a pre-existing locking element in the application; and
in response to the generating the code snippet, removing the pre-existing caching and locking elements from the application.

17. A computer-implemented method comprising:
determining a pairwise set of class-based and method-based abstract syntax trees (ASTs) of an application;
extracting features that specify an operating environment of the application, wherein the features include memory pressure, forecasted memory pressure, central processing unit (CPU) usage, forecasted CPU usage, disk pressure, forecasted disk pressure, network pressure, and forecasted network pressure;
inputting (i) the pairwise set of class-based and method-based ASTs and (ii) the features into a logical neural network (LNN), the features being input into the LNN using automatic reinforcement learning based on the operating environment;
generating symbolic feature vectors for the features by establishing bounds for the features and flattening the features;
inputting the symbolic feature vectors for the features and the pairwise set of class-based and method-based ASTs into a stacked transformer having encoders and decoders, the encoders and decoders being trained on word or token distributions of ASTs of code and bounds of operating environments associated with the ASTs of code; and
using the stacked transformer, generating a code snippet that replaces a portion of a method which is represented by a method-based AST included in the method-based ASTs, wherein the code snippet adds caching in the application, changes caching in the application, adds locking in the application, or changes locking in the application.

18. The method of claim 17, further comprising:
determining a first order logic (FOL) within the operating environment by using symbolic machine learning of class-based and method-based ASTs of applications; and
based on the FOL, generating an association between an AST of the application and parameters of the operating environment of the application, wherein the generating the code snippet is based on the association.

19. The method of claim 17, further comprising:
generating and training tuples by using passive reinforcement learning;
generating subsets of the LNN by using the trained tuples and first order logic within the operating environment; and
based on the generated subsets of the LNN, identifying a change in a portion of code of the application being related to parameters of the operating environment.

20. The method of claim 17, further comprising:
flattening first order logic (FOL) which is set within the operating environment;
flattening the ASTs included in the method-based ASTs; and
inputting the flattened FOL and the flattened ASTs into the stacked transformer, wherein the generating the code snippet is based on the flattened FOL and the flattened ASTs.
